(19) United States
(12) Patent Application Publication
(10) Pub. No.: US 2008/0315588 A1
(43) Pub. Date: Dec. 25, 2008

(54) EARTH CURRENT POWERED RADIAL OUTFLOW TURBOGENERATOR

(76) Inventor: Donald E. Burg, Miami, FL (US)

Correspondence Address: Donald E. Burg, 15840 S.W. 84 Avenue, Miami, FL, 33157, US

(21) Appl. No.: 11/546,169

(22) Filed: Oct. 11, 2006

Related U.S. Application Data
(63) Continuation-in-part of application No. 11/435,599, filed on May 17, 2006, now abandoned.
Application No. 11/435,599 is a continuation-in-part of application No. 11/443,978, filed on May 30, 2006, now abandoned.
Application No. 11/443,978 is a continuation-in-part of application No. 11/456,000, filed on Jun. 20, 2006.
Application No. 11/456,000 is a continuation-in-part of application No. 11/483,463, filed on Jul. 10, 2006, now abandoned.

(51) Int. Cl. F03B 13/10; F03B 15/08

(52) U.S. Cl. 290/52; 290/54; 415/42

(57) ABSTRACT

Presented is an improved concept for deriving power from flowing fluid currents in the form of a radial outflow turbine that drives a generator. Fluid normally enters the turbine rotor axially and exits radially through power generating elements. Such power generating elements may be airfoil or more blunt shaped where, in the latter instance, rotor rotational power is generated by trailing edge vortex forces acting on the power generating elements. The instant invention turbogenerator may be utilized in either gas or liquid and examples of both are given. Drive fluids are normally derived from the earth's natural occurring fluid currents.

### CROSS REFERENCE TO OTHER APPLICATIONS

This application is a continuation-in-part to Ser. No. 11/435,599 filed May 17, 2006; Ser. No. 11/443,978 filed May 30, 2006; Ser. No. 11/456,000 filed Jun. 20, 2006; and Ser. No. 11/483,463 filed Jul. 10, 2006.

### BACKGROUND OF THE INVENTION

The instant invention applies to the field of earth current powered turbogenerators where energy from the natural currents of the earth, be they wind or water, are utilized to power a turbine that in turn drives a generator. Such turbogenerators have been around for hundreds of years and have been used to do such things as grind grain and pump water. The generator normally produces electrical power in most of today's applications.

The leading Electrical Power Generation (EPG) systems at present are most commonly Horizontal Axis Wind Turbines (HAWT) with large generally three bladed propellers. HAWTs normally have their electrical generator mounted in line with the rotational centerline of the HAWT. Since these units are most efficient in large sizes the propeller diameters can reach up to 240 feet and the overall height of such units can be in the 400 foot area. The nacelle that houses the generator and its accessory equipment can be as large as a school bus and weight about 70 tons. Wind powered HAWTs, when operating in 15 knot winds, can produce about 1.2 MW (Mega Watts) of electricity.

A contender is the Vertical Axis Wind Turbine (VAWT) that has vertically oriented rotor vanes and a generator that is normally located in a base on the ground. The advantage here is that the generator is low and easy to get to. The rotor vanes are generally airfoil shaped and connect between discs located at each end, top and bottom in the case of a VAWT, of the rotor. Since oncoming fluid is impacting the rotor from the side, VAWTs have a limitation in that their airfoil shaped vanes are rotating upwind part of their rotation and downwind during another part. Both of these areas of operation, upwind and downwind, are inefficient and can actually add drag and not positive rotational torque. The only efficient rotational torque producing part of the VAWT vane's rotation is when the vanes are operating with the oncoming fluid impacting the vanes as an airplane wing where the oncoming fluid is at a reasonable angle attack to the airfoil shaped vane.

Both HAWT and VAWT designs can be applied to water currents also. Further, the VAWT can have its rotational centerline not only vertical but alternatively horizontal or any other angle to the oncoming fluid be that wind or water so long as the rotational centerline of its rotor is perpendicular to the oncoming fluid.

The instant invention takes a different tack in that the oncoming fluid comes into one end of the rotor and exits radially outward through the rotor's vanes. So we have a general rotor shape that is similar to a VAWT but the oncoming fluid does not go though the rotor from side to side like on the VAWT. As such the instant invention's vanes produce a positive rotational force over their full 360 degrees of rotor rotation. What this means also is that the instant invention's rotor vanes can be optionally designed since they always see fluids approaching from the same direction. This differs from the VAWT concept where the vanes have to be a compromise design due their seeing different approach velocities during every portion of their rotor's rotation.

The instant invention is applicable to both wind and water fluid flows. It may utilize airfoil shaped vanes, vortex force generating shaped vanes, or other vane shapes dependent upon the application requirements. It is ideally suited for modular high volume low cost production so that a number of the modules may be easily and cheaply deployed. In the case of its use in water currents, such as ocean currents like the Gulfstream or tidal currents, it may be mounted on a submersible system that is easy to surface for cleaning and maintenance of the modules. In the case where it would be used in wind areas it would generally be mounted as a bundle or array of modules fixed together. All of this is explained in detail in the body of the application that follows.

### SUMMARY OF THE INVENTION

A primary object of the instant invention is to provide an improved turbogenerator that derives energy for power generation from flowing fluids.

A related object of the invention is that it have a rotor having a rotor rotational centerline with said rotor having rotor primary fluid driven elements that are more parallel to than perpendicular to said rotor rotational centerline.

A directly related object of the invention is that the rotor receive flowing fluids through an inlet in said rotor.

A further related object of the invention is that said flowing fluids passing outward through the rotor primary fluid driven elements be in directions at least primarily radially outward away from the rotor rotational centerline to thereby produce forces on the rotor primary fluid driven elements.

A directly related object of the invention is that said forces acting on the rotor primary fluid drive elements in turn produce rotational forces on the rotor.

A further directly related object of the invention is that the rotational forces are transmitted from said rotor to a generator portion of said turbogenerator to thereby produce power.

It is yet a further object of the invention that it further comprise one or more rotor fluid guide elements that are oriented more perpendicular to than parallel to the rotor rotational centerline and disposed to aid in directing flowing fluids radially outward through the rotor primary fluid driven elements.

It is a directly related object of the invention that said rotor fluid guide elements are in mechanical communication with and rotate with said rotor primary fluid driven elements.

Another object of the invention is that the rotor primary fluid elements be, at least primarily, airfoil shaped.

Yet another object of the invention is that it further comprise rotor secondary fluid driven elements that are more perpendicular to than parallel to said rotor rotational centerline and in mechanical communication with and disposed between a hub of said rotor and the rotor primary fluid elements and proximal the inlet of said rotor.

It is a related object of the invention that said rotor secondary fluid driven elements are, at least primarily, airfoil shaped.

A further object of the invention is that the generator of said turbogenerator be disposed, at least partially, internal to a hub of said turbogenerator's rotor.

Yet another object of the invention is that the rotor primary fluid driven elements, when driven by passing fluids, may have a trailing edge vortex wherein said trailing edge vortex results in a force on the rotor primary fluid driven elements resulting in a positive rotational force on the rotor.

A directly related object of the invention is that said rotor primary fluid driven elements may be at least partially truncated over their aft portions.

A further object of the invention is that said improved turbogenerator may be mounted on a submersible device and driven by passing water currents when said submersible device is submerged.

A related object of the invention is that the submersible device be capable of rising to a water surface by evacuating water from internal said submersible device.

A further related object of the invention is that said submersible device may utilize compressed gas means to evacuate water from internal the submersible device.

Yet another related object of the invention is that two or more of said improved turbogenerators may be mounted on the submersible device and at least one of said improved turbogenerators may be rotatable outward from the submersible device.

Still another related object of the invention is that it may further comprise mooring means to secure the submersible device in the passing water currents.

Another related object of the invention is that it may further comprise a tower in mechanical communication with the submersible device and the water surface when the submersible device is submerged.

Yet another related object of the invention is that it may further comprises a buoy disposed forward of the submersible device whereby said buoy is capable of submerging independent of the submersible device.

Still another object of the invention is that two or more of said improved turbogenerators may be mounted together in an array.

A directly related object of the invention is that the array be rotatable to thereby orient fluid inlets of the improved turbogenerators in line with oncoming fluid currents.

### BRIEF DESCRIPTION OF THE DRAWINGS

FIG. 1 presents a head on view of the instant invention. In this case it is a single module improved turbogenerator that is suitable for mass production at low cost.

FIG. 2 is a side view of the instant invention in its preferred embodiment.

FIG. 3 is the same head on view as given in FIG. 1 but in this case there is no inlet grille done to simplify the figure. Note that inlet grille, while preferred to prevent injury to wildlife and damage to the instant invention's rotor, is optional.

FIG. 4 is a cross-section, as taken through plane 4-4 of FIG. 3, that shows an airfoil shaped rotor secondary fluid driven elements that connect a hub of the rotor to a member that supports the rotor's primary fluid driven elements.

FIG. 5 is another cross-section, as taken through plane 4-4 of FIG. 4, that show the same airfoil shaped secondary fluid driven elements member but at a larger radius.

FIG. 6 is a cross-sectional view, as taken though plane 6-6 of FIG. 3, that shows a side view of internal workings of the preferred embodiment module.

FIG. 7 gives a cross-sectional view, as taken through plane 7-7 of FIG. 6, that shows a preferred embodiment arrangement of rotor primary fluid driven elements as they would disposed around the rotor.

FIG. 8 is a view of the rotor primary fluid driven element noted as A in FIG. 7. This shows the preferred embodiment and gives a vector analysis of the forces around the rotor primary fluid driven element.

FIG. 9 shows another version of the rotor primary fluid driven element noted as A in FIG. 7. This version is presented as a comparison to the preferred embodiment given in FIG. 8.

FIG. 10 presents a rear view of the module presented in FIG. 1.

FIG. 11 gives an alternative approach to the rotor primary fluid driven element concept. In this instance the rotational force is provided by a vortex generated aft of a more blunt body than the airfoil shape rotor primary fluid driven elements of FIGS. 7-9. This is a different approach to rotational force generation compared to an airfoil. Rotational force is generated by a vortex formed behind the fluid driven element's rather blunt body. In many cases this concept is more efficient than an airfoil shape.

FIG. 12 is a cross-section of the rotor primary fluid driven element B showing how vortex form around a round rod shaped rotor primary fluid driven element.

FIG. 13 shows the actual forces that work on the rotor primary fluid driven element B as a result of the vortex.

FIG. 14 presents a more streamlined and hence more efficient version of the round rod shaped rotor primary fluid driven element of FIGS. 12 and 13.

FIG. 15 presents improvement to the shape of the rotor primary fluid driven element presented in FIG. 14. Note the sharp breaks that induce the passing fluid to separate cleanly and thereby help in forming a following vortex.

FIG. 16 gives yet another variation of a rotor primary fluid driven element that has a vortex generated force. In this case a concave shape has been designed into its aft surface.

FIG. 17 presents another variation of a rotor primary fluid driven element that is powered by a vortex generated force. In this instance the aft surface is angled upward to help deflect the generated vortex up and away from a following rotor primary fluid driven element.

FIG. 18 illustrates a tethered submersible platform that is supporting three of the instant invention turbogenerator modules in what is a submersible power generating module assembly. In this illustration the submersible platform is in its surfaced mode with the aft two modules rotated inboard for transportation and/or cleaning of the modules. A connecting buoy is also shown.

FIG. 19 is a side view of the assembly of FIG. 18.

FIG. 20 is a bow on view of the assembly of FIGS. 18 and 19.

FIG. 21 shows the submersible turbogenerator module assembly in its submerged power generating mode. The two aft modules are deployed outward into the oncoming water flow to thereby generate power.

FIG. 22 is a side view of the submerged turbogenerator module assembly first presented in FIG. 21.

FIG. 23 is a bow on view of the submerged turbogenerator module assembly shown in FIGS. 21 and 22.

FIG. 24 is a cross-section, as taken through plane 24-24 of FIG. 23, that shows a section of a typical anchor or mooring device used to secure the submerged turbogenerator module assembly.

FIG. 25 presents a topside view of an embellishment of the submerged turbogenerator module assembly from FIGS. 21-23. In this case, there is a tower that rises through the water surface and helps maintain a specified depth for the submerged turbogenerator module assembly.

FIG. 26 is a side view of the assembly presented in FIG. 25. Note that the tower has a larger volume and hence greater flotation over its upper portions. This concept is utilized to maintain the assembly at a proper depth and also, due to its preferred airfoil shape, is very seaworthy and has low drag to passing water currents.

FIG. 27 is a bow on view of the assembly presented in FIGS. 25 and 26.

FIG. 28 presents a cross-section, as taken through plane 28-28 of FIG. 26, of a section of the tower that includes passageways for personnel, equipment, control systems, compressed gas lines, and the like.

FIG. 29 is a view of the preferred embodiment of the submersible support platform or device with its deck covering removed to show its internal components.

FIG. 30 presents a cross-sectional view, as taken through plane 30-30 of FIG. 29, that shows a side view of the internal workings of the submersible support platform.

FIG. 31 gives a top view, as taken with its top covering removed, of a buoy that would normally be used to support power lines and connecting positioning cables. This is especially valuable when the submersible support platform is disconnected.

FIG. 32 shows internal components of the buoy. In this instance there is a high level of water internal to the buoy as is the case when the submersible support platform is connected and submerged.

FIG. 33 is a similar view as given in FIG. 32 but in this instance the buoy is evacuated of almost all water ballast and floating on the surface.

FIG. 34 shows the buoy in its disconnected and submerged to the bottom of the sea floor condition. This is the case when there is no submersible support platform connected and it is desired to have all cables submerged and out of the way of passing watercraft. Note that it is possible to send an underwater signal to a controller in the buoy that directs compressed gas tank valves in the buoy to vent gas and expel water from the buoy thereby causing the buoy and its attached cables to rise to the surface.

FIG. 35 shows a cross section of a typical anchoring or mooring system. Note that the power cable runs under the sea floor in this example.

FIG. 36 presents a top view of an assembly that has two or more of the instant invention turbogenerator modules attached together in an array.

FIG. 37 is a side view of the assembly illustrated in FIG. 36. Note that means to rotate the module assembly array above a fixed base is provided here.

FIG. 38 gives a head on view of the assembly presented in FIGS. 36 and 37. While some 12 preassembled torbogenerator modules are shown here, any number may be attached together. This is a good way to employ the instant invention in a wind power application where having a large frontal area is necessary to produce high power outputs.

FIG. 39 gives a side view of a single module of the array of FIGS. 36-38.

FIG. 40 shows a head on view of the single module of FIG. 39. Note that this variation has a full support frame so that it has a full rectangular head on surface. This is valuable when doing an array of modules since oncoming fluids are directed to the module entrances and not allowed to pass between modules.

### DETAILED DESCRIPTION

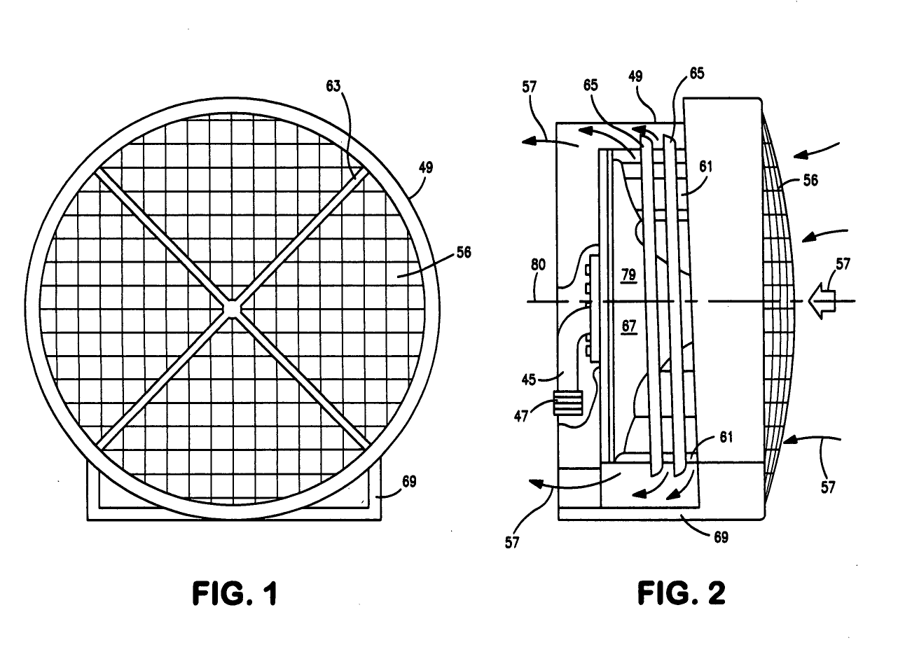

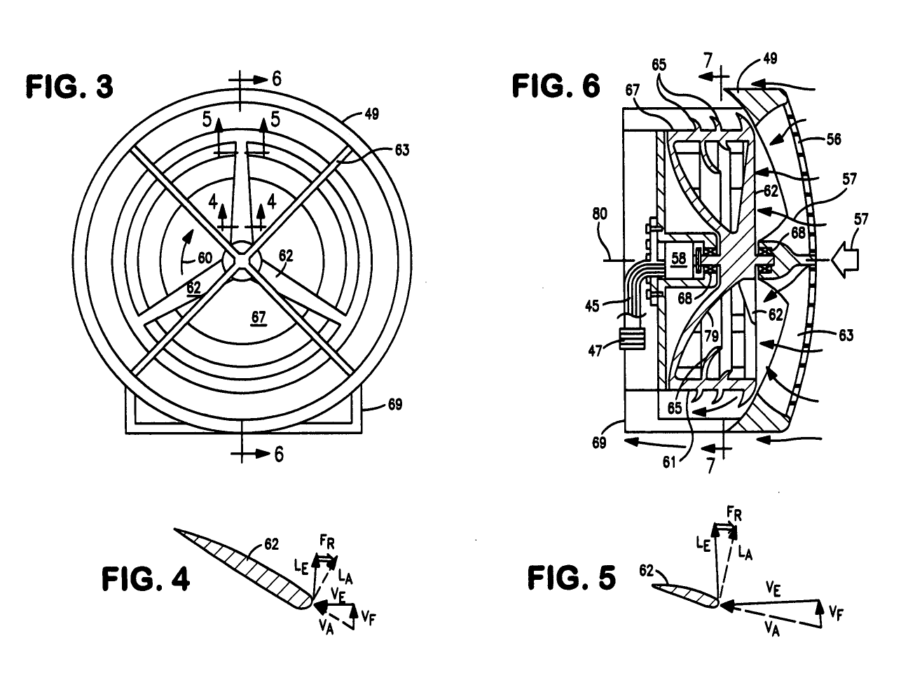

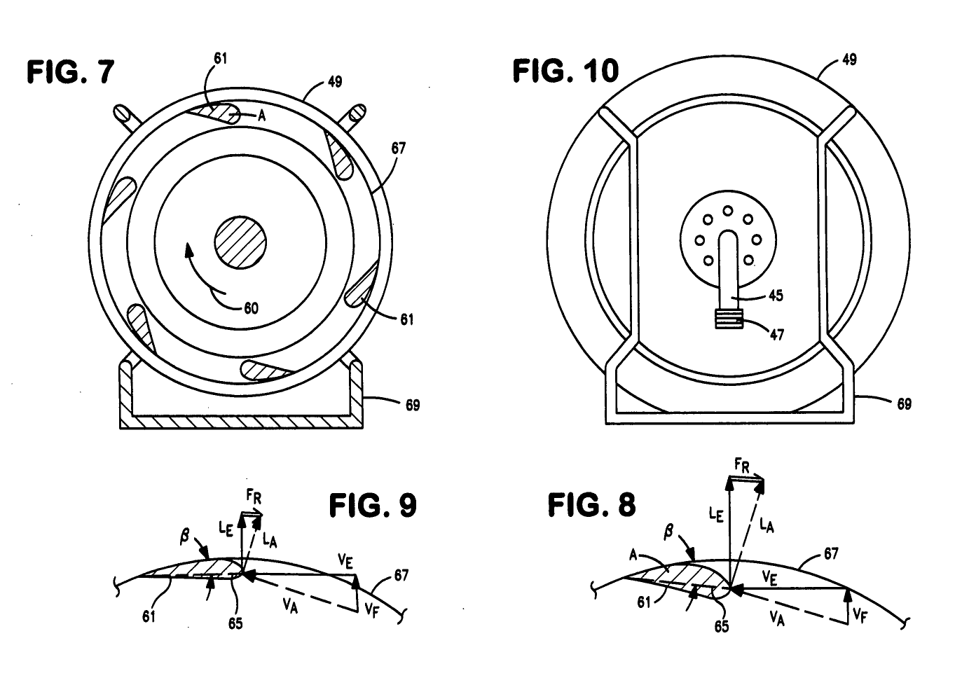

FIG. 1 presents a head on view of the instant invention earth current powered turbogenerator module 49. This includes an optional inlet grille 56, inlet grille support structure bars 63, and base support frame 69. The use of a modular concept results in a mass production product that keeps costs reasonable.

FIG. 2 is a side view of the instant invention in its preferred embodiment module form. Items shown include fluid flow arrows 57, power output cable 45, cable connector 47, rotor 67, rotor hub 79, rotor rotational centerline 80, and rotor radial outflow guide vanes or, as termed herein, rotor fluid guide elements 65. These rotor fluid guide elements 65 redirect the oncoming fluid into a more radial direction so they pass outward through rotor primary fluid driven elements 61 that are normally disposed proximal a periphery of the rotor 67. More on shape and substance of variations of rotor primary fluid driven elements 61 under the descriptions of FIGS. 7-9 and 11-17.

FIG. 3 is the same head on view as given in FIG. 1 but in this case the inlet grille has been omitted to simplify the figure. Note that inlet grille, while preferred to prevent injury to wildlife and damage to the instant invention's rotor 67, is optional. Preferred embodiment inlet radial connector vanes or, as termed herein, rotor secondary fluid driven elements 62 that are preferably at an inlet end of the rotor 67 are also shown. Further, the rotor hub 79 is shown in this figure.

FIG. 4 is a cross-section, as taken through plane 44 of FIG. 3, that shows an airfoil shaped radially oriented rotor secondary fluid driven element 62. These radially oriented vanes or rotor secondary fluid driven elements 62 are preferably airfoil shaped as shown with a larger chord length closer to the rotor's hub. Since the local rotational velocity of an element of a rotor secondary fluid driven element 62 is in direct proportion to its radial distance from the rotor's hub it also should have a more twisted or higher angle of attack at a small radius than at a larger radius. By vector analysis we have the local element rotational velocity VE and oncoming fluid velocity VF which results in the local velocity of approach VA that the element 62 sees. The resulting theoretical lift from rotational velocity is LE and the actual lift is LA. The resulting rotational force is FR which is the rotational force applied to the rotor. This is all similar to how a HAWT works except that the instant invention utilizes these radially oriented rotor secondary fluid driven elements 62 normally at a forward inlet end of the rotor mainly as connecting structural elements. It is best to keep these radially oriented elements 62 as small as possible to prevent their interfering with the more axially oriented and more efficient rotor primary fluid driven elements positioned proximal a periphery of the rotor that see mostly radial outward fluid flow.

FIG. 5 is another cross-section, as taken through plane 4-4 of FIG. 4, that show the same airfoil shaped rotor secondary fluid driven element 62 but at a larger radius. Note the shallower angle or twist here. This is because, due to the larger radius, the local velocity VE of the vane is much higher. It is of note that the best efficiencies of HAWTs appear to be with the peripheral velocity of the blades at about six times the velocity of the approaching fluid. For possible interest, this means that a 240 foot diameter HAWT propeller rotor working in a 15 knot wind rotates at only about 12 RPM or, looking at it another way, takes about five seconds to complete a rotation.

FIG. 6 is a cross-sectional view, as taken though plane 6-6 of FIG. 3, that shows a side view of internal workings of a preferred embodiment turbogenerator module 49. The inlet rotor secondary fluid driven elements 62 normally connect the rotor hub 79 with the more axial than radial oriented rotor primary fluid driven elements 67. Rotor fluid guide elements 65 are at least primarily radially oriented and are used to direct fluid flow outward in a more radial than axial direction through the rotor primary fluid driven elements 67. The rotor secondary fluid driven elements 65 are normally in structural communication with the rotor primary fluid driven elements 67.

FIG. 7 gives a cross-sectional view, as taken through plane 7-7 of FIG. 6, that shows a preferred embodiment arrangement of more axial than radial oriented, in relation to the rotor's rotational centerline 80, rotor primary fluid driven elements 61 that are disposed around the rotor 67.

FIG. 8 is a view of the rotor primary fluid driven element 61 noted as A in FIG. 7. This shows the preferred embodiment and gives a vector analysis of the forces around the rotor primary fluid driven element 61. The chord 65 of the airfoil shaped element 61 is shown to give orientation reference.

FIG. 9 presents another version of a rotor primary fluid driven element 61 noted as A in FIG. 7. This version is presented as a comparison to the more efficient preferred embodiment given in FIG. 8.

FIG. 10 presents a rear view of the inventive turbogenerator module 49 that was presented in a head on view in FIG. 1.

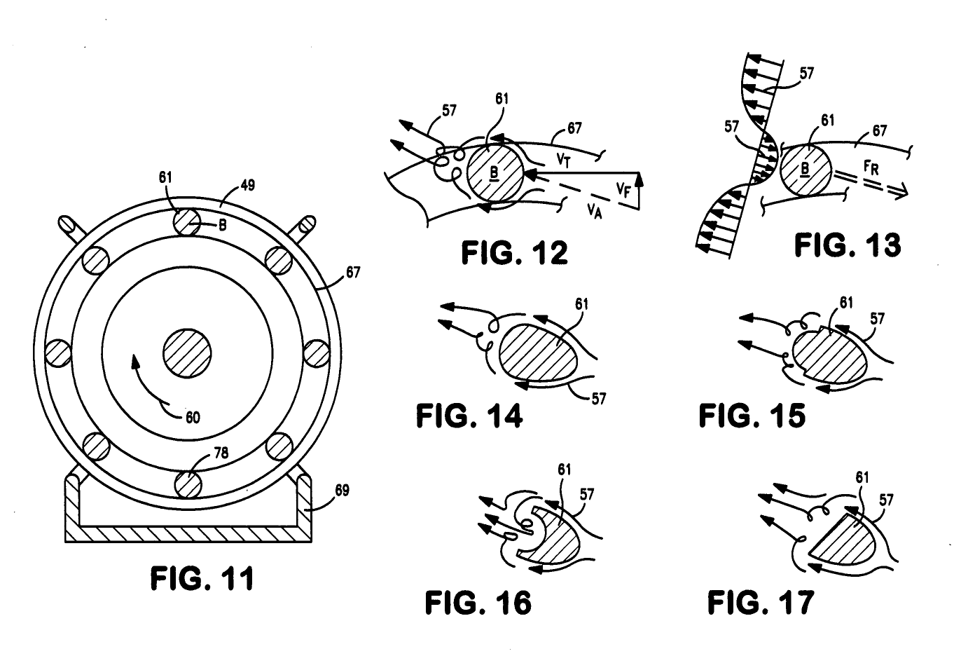

FIG. 11 gives an alternative approach to the rotor primary fluid driven element 61 concept. In this instance the rotational force is provided by a vortex generated aft of a more blunt body than the airfoil shape rotor primary fluid driven elements of FIGS. 7-9. This is a different approach to rotational force generation compared to an airfoil. Rotational force is generated by a vortex formed behind the rather blunt body of the rotor primary fluid driven element 61 shown here.

FIG. 12 is a cross-section of rotor primary fluid driven element B showing how a vortex forms around the round rod shaped fluid element here.

FIG. 13 shows the actual forces that work on the more full bodied or blunt rotor primary fluid driven element B as a result of the vortex.

FIG. 14 presents a more streamlined and hence more efficient version of the round rod shaped rotor primary fluid driven element 61 of FIGS. 12 and 13.

FIG. 15 presents improvement to the shape of the blunt shaped rotor primary fluid driven element 61 presented in FIG. 14. Note the sharp breaks that induce the driving fluid to separate cleanly when forming a following vortex.

FIG. 16 gives yet another variation of a rotor primary fluid driven element 61 with a vortex generated force. In this case a concave shape has been designed into its aft surface that aids in generating vortex forces working in the direction of rotor rotation.

FIG. 17 presents another variation of a rotor primary fluid driven element 61 that is powered by a vortex generated force. In this instance the aft surface is angled upward to help deflect the generated vortex up and away from a following rotor primary fluid driven element.

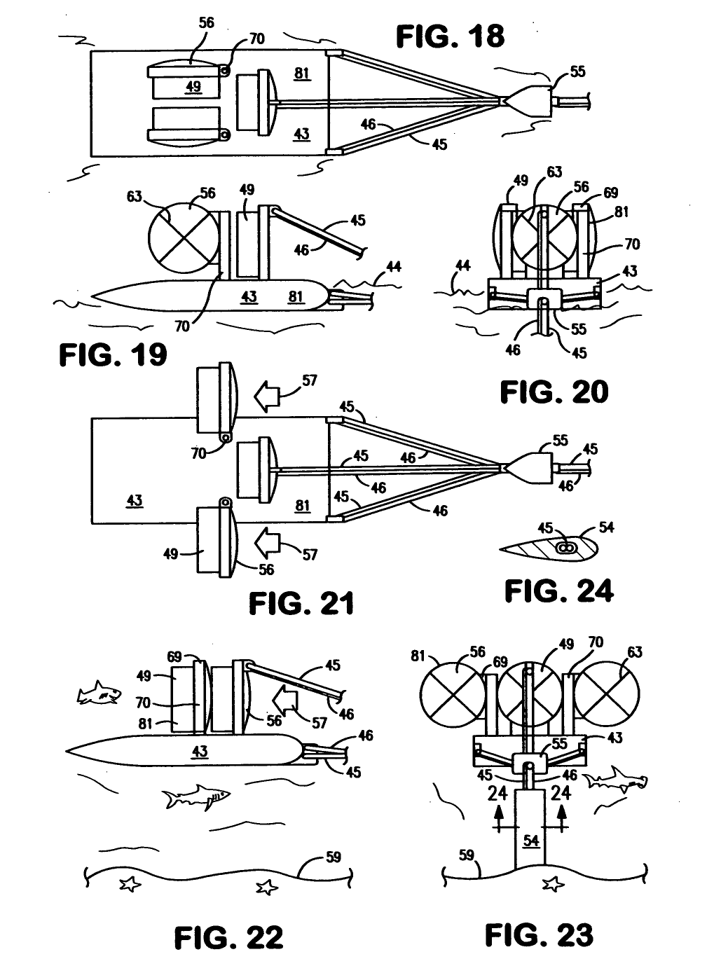

FIG. 18 illustrates a tethered submersible platform or device 43 that is supporting three of the instant invention turbogenerator modules 49 in what can be called a submersible turbogenerator module assembly 81. In this illustration the submersible device 43 is in its surfaced mode with the aft two modules rotated inboard for transportation and/or cleaning of the modules. A connecting buoy 55, rotating hinge 70, power cables 45, and connecting cables 46 are also shown. Note that the turbogenerators modules 49 themselves are shown in outline form only in this and following figures to simplify the figures.

FIG. 19 is a side view of the assembly of FIG. 18. A typical waterline 44 is shown here.

FIG. 20 is a bow on view of the assembly of FIGS. 18 and 19.

FIG. 21 shows the submersible turbogenerator module assembly 81 in its submerged power generating mode. The two aft modules 49 are deployed outward from hinge 70 into the oncoming water currents to thereby generate power.

FIG. 22 is a side view of the submerged turbogenerator power generating module assembly 81 first presented in FIG. 21. This view also shows the sea floor 59.

FIG. 23 is a bow on view of the submersible turbogenerator module assembly 81 shown in FIGS. 21 and 22.

FIG. 24 is a cross-section, as taken through plane 24-24 of FIG. 23, that shows a section of a typical anchor or mooring device 54 used to secure the submerged power generating module assembly 81. Note its low drag airfoil shape and the fact that cables 54 pass though it.

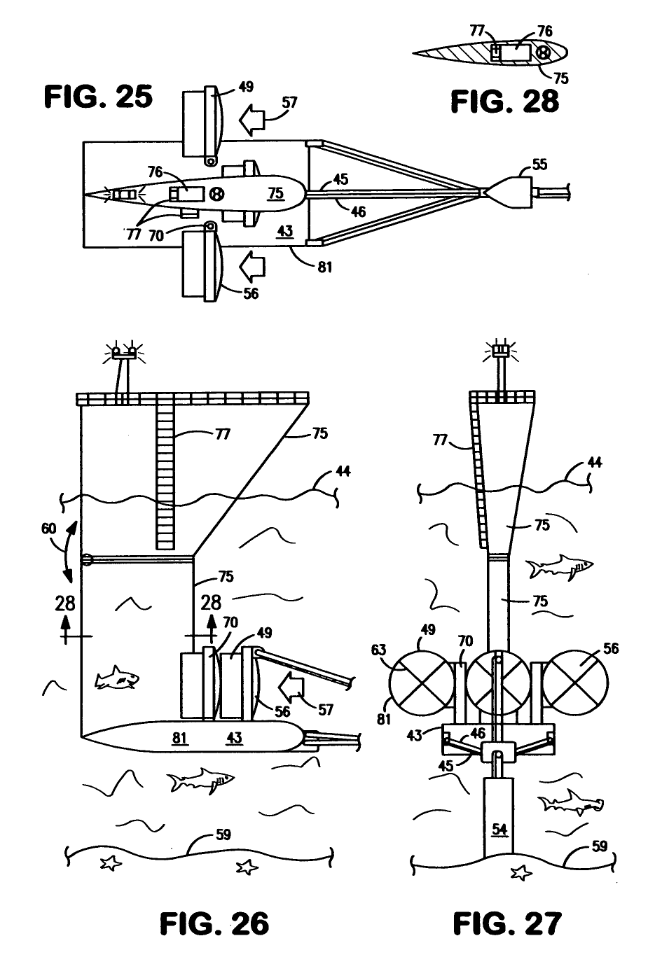

FIG. 25 presents a topside view of an embellishment of the submerged turbogenerator module assembly 81 of FIGS. 21-23. In this case, there is a tower 75 that rises through the water surface 44 and helps maintain a specified depth for the submerged turbogenerator module assembly 81.

FIG. 26 is a side view of the assembly presented in FIG. 25. Note that the tower 75 has a larger volume and hence greater flotation over its upper portions. This feature allows the tower to act as a depth control system for the submerged turbogenerator module assembly 81.

FIG. 27 is a bow on view of the assembly presented in FIGS. 25 and 26.

FIG. 28 presents a cross-section, as taken through plane 28-28 of FIG. 26, of a section of the tower 75 that includes passageways 76 for personnel, equipment, control systems, compressed gas lines, and the like. A personnel ladder 77 is also shown.

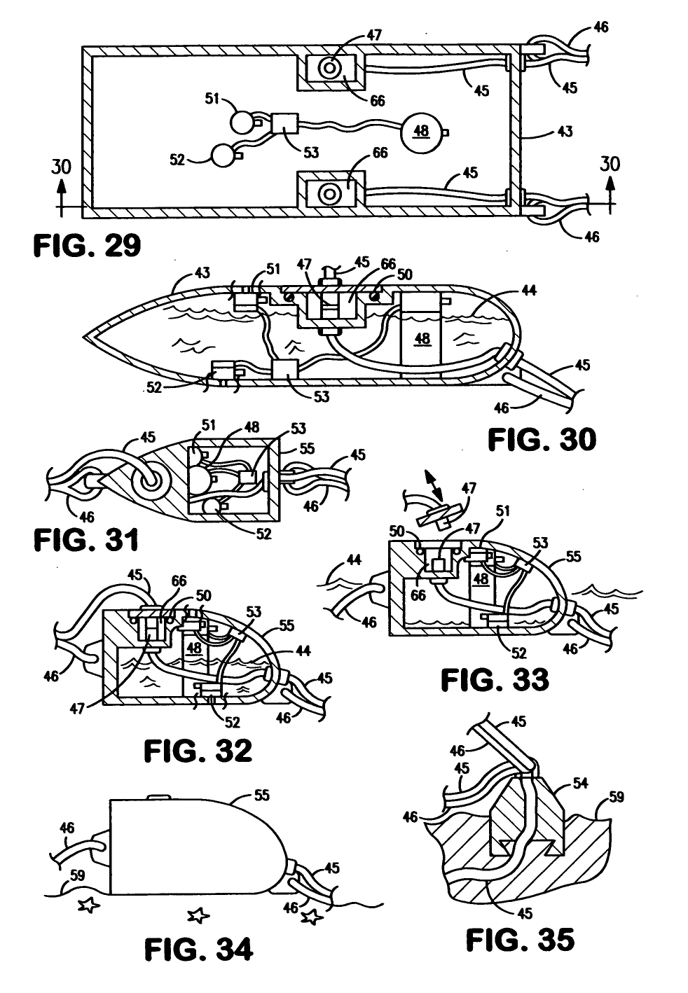

FIG. 29 is a view of the preferred embodiment of the submersible support device 43 with its deck covering removing to show its internal components. These include a compressed gas tank 48, gas vent valve 51, water vent valve 52, control module 53, connector voids 66, and power cable connectors 47.

FIG. 30 presents a cross-sectional view, as taken through plane 30-30 of FIG. 29, that shows a side view of the internal workings of the submersible support device 43. Note that the waterline 44 is high inside the submersible support device 43 here which is the case when it is submerged. A preferred way to raise the submerged support device 43 is to send an underwater signal to the control module 53 that in turn vents water from vent valve 52 and releases compressed gas from the compressed gas tank 48. To submerge, the procedure is open the water vent valve 52 to allow water in and open gas vent valve 51.

FIG. 31 gives a top view, as taken with its top covering removed, of a buoy 55 that would normally be used to support power lines 45 and connecting positioning cables 46. This is especially valuable when the submersible support platform 43 is disconnected. The buoy contains the same type of equipment for raising and lowering it as does the main submersible support device of FIGS. 29 and 30.

FIG. 32 shows internal components of the buoy 55 in its submerged condition. In this instance there is a high level of water internal to the buoy 55 as is the case when the submersible support device is connected and also submerged.

FIG. 33 is a similar view as given in FIG. 32 but in this instance the buoy 55 is evacuated of almost all water ballast and floating on the water surface as indicated by waterline 44.

FIG. 34 shows the buoy 55 in its disconnected and submerged to the sea floor 59 condition. This is the case when there is no submersible support device connected and it is desired to have all cables submerged and out of the way of passing watercraft. Note that it is possible to send an underwater signal to a controller in the buoy 55 that directs compressed gas tank valves in the buoy 55 to vent gas and expel water from the buoy 55 thereby causing the buoy 55 and its attached power lines 45 and cables 46 to rise to the surface.

FIG. 35 shows a cross section of a typical anchoring or mooring device 54. Note that the power cable 45 runs under the sea floor to shore in this example.

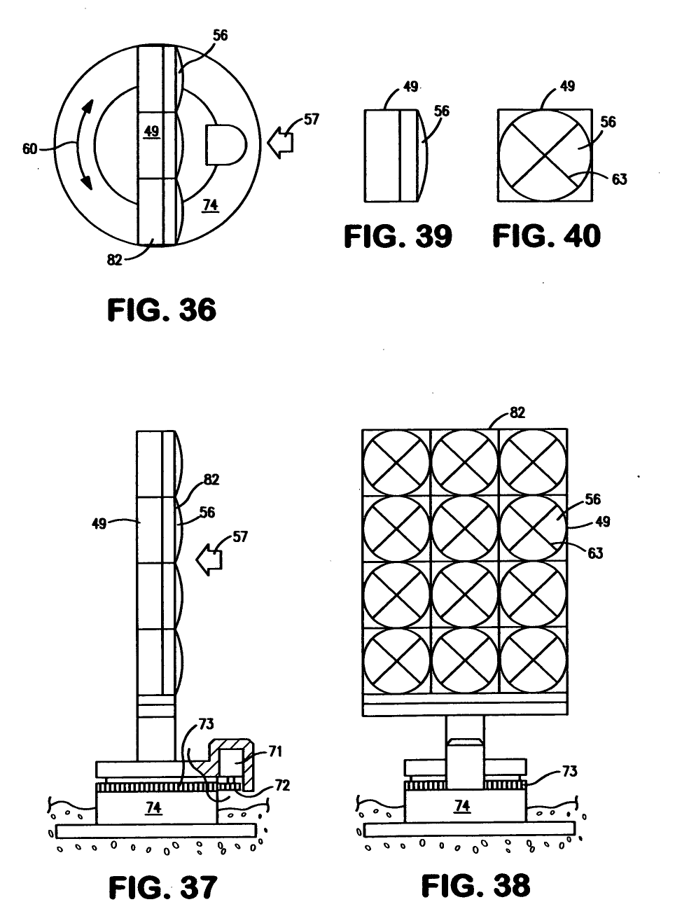

FIG. 36 presents a top view of an assembly that has several or more of the instant invention turbogenerator modules 49 arranged in a module assembly array 82.

FIG. 37 is a side view of the module assembly array 82 illustrated in FIG. 36. Note that means to rotate the module assembly array 82 above a fixed base 74 is provided in the form of a drive motor 71 and gear 72 that rotate around gear track 73 to thereby rotate the module assembly array 82 so that it faces oncoming fluid currents.

FIG. 38 gives a head on view of the module assembly array 82 presented in FIGS. 36 and 37. While some 12 preassembled turbogenerator modules 49 are shown here, any number may be attached together. This is a good way to employ the instant invention in a wind power application where having a large frontal area is necessary to produce high power outputs.

FIG. 39 gives a side view of a single turbogenerator module 49 of the array of FIGS. 36-38.

FIG. 40 shows a head on view of the single turbogenerator module 49 of FIG. 39. Note that this variation has a full support frame 69 so that it has a full rectangular head on surface. This is valuable when doing an array of modules since oncoming fluids are directed to the module entrances and not allowed to pass between modules.

While the invention has been described in connection with a preferred and several alternative embodiments, it will be understood that there is no intention to thereby limit the invention. On the contrary, there is intended to be covered all alternatives, modifications, and equivalents as may be included within the spirit and scope of the invention as defined by the appended claims, which are the sole definition of the invention.

What I claim is:

1. In an improved turbogenerator that derives energy for power generation from flowing fluids, the improvement comprising:
said improved turbogenerator mounted on a submersible supporting device and driven by passing water currents when said submersible supporting device is submerged and wherein said submersible supporting device is capable of rising to a water surface and which further comprises a buoy disposed forward of the submersible supporting device wherein said buoy is capable of submerging independent of the submersible supporting device and which further comprises a rotor having a rotor rotational centerline with said rotor having rotor primary fluid driven elements that are more parallel to than perpendicular to said rotor rotational centerline, the rotor receiving flowing fluids through an inlet in said rotor, said flowing fluids passing outward through the rotor primary fluid driven elements in directions at least primarily radially outward away from the rotor rotational centerline, said radially outward directed flowing fluids produce forces on the rotor primary fluid driven elements, said forces in turn produce rotational forces on the rotor, and said rotational forces are transmitted from said rotor to a generator portion of said turbogenerator to thereby produce power and one or more rotor fluid guide elements that are oriented more perpendicular to than parallel to said rotor rotational centerline and disposed to aid in directing flowing fluids radially outward through the rotor primary fluid driven elements.

2. (canceled)

3. The improved turbogenerator of claim 1 wherein said rotor fluid guide elements are in mechanical communication with and rotate with said rotor primary fluid driven elements.

4. The improved turbogenerator of claim 1 wherein the rotor primary fluid elements are, at least primarily, airfoil shaped.

5. The improved turbogenerator of claim 1 which further comprises rotor secondary fluid driven elements that are more perpendicular to than parallel to said rotor rotational centerline and in mechanical communication with and disposed between a hub of said rotor and the rotor primary fluid elements and proximal the inlet of said rotor.

6. The improved turbogenerator of claim 5 wherein said rotor secondary fluid driven elements are, at least primarily, airfoil shaped.

7. The improved turbogenerator of claim 2 wherein the generator of said turbogenerator is disposed, at least partially, internal to a hub of said turbogenerator's rotor.

8. The improved turbogenerator of claim 1 wherein the rotor primary fluid driven elements, when driven by passing fluids, have a trailing edge vortex wherein said trailing edge vortex results in a force on the rotor primary fluid driven elements resulting in a positive rotational force on the rotor.

9. The improved turbogenerator of claim 8 wherein said rotor primary fluid driven elements are at least partially truncated over their aft portions.

10. (canceled)

11. The improved turbogenerator of claim 1 wherein said submersible supporting device utilizes compressed gas means to evacuate water from internal the submersible supporting device.

12. The improved turbogenerator of claim 1 wherein two or more of said improved turbogenerators are mounted on the submersible supporting device and wherein at least one of said improved turbogenerators is rotatable outward from said submersible supporting device.

13. The improved turbogenerator of claim 1 which further comprises mooring means to secure the submersible supporting device in the passing water currents.

14. The improved turbogenerator of claim 1 which further comprises a tower wherein said tower is in mechanical communication with the submersible device and the water surface when the submersible supporting device is submerged.

15. (canceled)

16. The improved turbogenerator of claim 1 wherein two or more of said improved turbogenerators are mounted together in an array and wherein said array is rotatable to thereby orient fluid inlets of the improved turbogenerators in line with oncoming fluid currents.

17. In an improved turbogenerator that derives energy for power generation from flowing fluids, the improvement comprising:
two or more of said improved turbogenerators are mounted on a submersible supporting device and driven by passing water currents when said submersible supporting device is submerged in water currents, at least one of said improved turbogenerators is rotatable outward from said submersible supporting device, said submersible supporting device capable of rising to a water surface by evacuating water from internal said submersible supporting device, mooring means capable of securing the submersible supporting device in the passing water currents, and a buoy disposed forward of the submersible supporting device wherein said buoy is capable of submerging independent of the submersible supporting device.

18. The improved turbogenerator of claim 17 wherein said submersible supporting device utilizes compressed gas means to evacuate water from internal the submersible device.

19. The improved turbogenerator of claim 17 which further comprises a tower wherein said tower is in mechanical communication with the submersible supporting device and the water surface when the submersible supporting device is submerged.

20. (canceled)

21. (canceled)

22. (canceled)

23. (canceled)
